(19) United States
(12) Patent Application Publication
(10) Pub. No.: US 2022/0263172 A1
(43) Pub. Date: Aug. 18, 2022

(54) MODULE HOUSING, METHOD OF MANUFACTURING A MODULE HOUSING, AND BATTERY MODULE

(71) Applicant: Lisa Draexlmaier GmbH, Vilsbiburg (DE)

(72) Inventors: Guido HOFER, Weng (DE); Michael STECKEL, Vilsbiburg (DE); Peter FAL TERMEIER, Landshut (DE); Andreas ERLER, Straubing (DE); Klaus HILMER, Atting (DE); Sahin CEMIL, Vilsbiburg (DE)

(21) Appl. No.: 17/667,576

(22) Filed: Feb. 9, 2022

(30) Foreign Application Priority Data
Feb. 9, 2021 (DE) 10 2021 102 975.9

(51) Int. Cl. H01M 50/213; H01M 50/227; H01M 50/293

(52) U.S. Cl. CPC H01M 50/213; H01M 2220/20; H01M 50/293; H01M 50/227

(57) ABSTRACT

A module housing made of an electrically insulating plastic material is disclosed. The module housing has a foam body made of an electrically insulating foam material, the foam body having substantially cylindrical receptacles for round cells. The module housing includes axial stops aligned with the receptacles for cell cups of the round cells and recesses for positive terminals of the round cells. The module housing may be used in a battery module.

### CROSS REFERENCE TO RELATED APPLICATIONS

This application claims priority to German patent application DE10 2021 102 975.9 filed on Feb. 9, 2021, the content of which is herein incorporated by reference.

### BACKGROUND OF THE INVENTION

### Field of the Invention

The present invention relates to a module housing made of an electrically insulating plastic material, a method of manufacturing such a module housing, and a battery module comprising such a module housing.

### Description of Related Art

The present invention is described below primarily in connection with traction batteries for vehicles. However, the invention can be used for any application in which battery modules are to be assembled from individual round cells.

To achieve a desired electrical voltage of the battery module, a plurality of round cells can be connected in series. To achieve a desired electrical capacity of the battery module, a plurality of round cells connected in parallel can each be connected in series.

To connect two round cells in series, they can be axially aligned. The positive pole of the first round cell is always connected to the negative pole of the second round cell. In general, the positive poles are arranged centrally on the end faces of the round cells, while the cell cups of the round cells form the negative poles. The cell cups of the axially aligned round cells must therefore not touch each other in order to prevent a short circuit of the first round cell.

To prevent the cell cup of the second round cell from coming into contact with the cell cup of the first round cell, an insulating washer can be conventionally arranged between the round cells. The insulating disk may have a hole for the positive pole of the first round cell. The insulating washer can, for example, be glued to at least one of the two round cells.

### BRIEF SUMMARY OF THE INVENTION

It is therefore an object of the invention to provide an improved module housing, an improved method for manufacturing such a module housing, and an improved battery module with such a module housing, using means that are as simple as possible in terms of construction.

The approach presented here allows round cells arranged in parallel to be kept defined in all spatial directions and, in addition, the cell cups of series-connected round cells used as the negative pole can be electrically insulated from each other to prevent short circuits. A separate insulator can be dispensed with in this case.

A module housing made of an electrically insulating plastic material with a foam body made of an electrically insulating foam material is proposed, the foam body having substantially cylindrical receptacles for round cells, the module housing having axial stops aligned with the receptacles for cell cups of the round cells and recesses for positive poles of the round cells.

Furthermore, a battery module with at least one module housing according to the approach presented here is proposed, wherein one round cell per receptacle is arranged in the foam body, wherein cell cups of the round cells abut against an inner side of the stops and positive poles of the round cells are arranged in the recesses, wherein cell connectors abut against an outer side of the stops and are electrically conductively connected to the positive poles, wherein the cell connectors are electrically insulated from the cell cups by the stops. The receptacles for the round cells are substantially cylindrical, i.e., they are cylindrical receptacles, notwithstanding usual tolerances.

Furthermore, a method for manufacturing such a module housing is proposed, wherein the module housing with the stops and recesses is made of an electrically insulating plastic material and the foam body with the receptacles is formed and foamed in a foaming tool from an electrically insulating foam material.

A round cell can be a cylindrical battery cell. The round cell can have a cell cup that encloses a roll of several electrically effective layers. The positive pole of the round cell can be arranged in the center or core of the roll. The cell cup can form the negative pole of the round cell.

A battery module can be an assembly of many round cells in a housing. The battery module can have two connection terminals to which the round cells are electrically connected. The round cells can be electrically connected in series between the connection terminals, with at least one positive terminal always being connected to at least one negative terminal of another round cell. The positive poles and negative poles may be interconnected by the cell connectors. Likewise, the round cells can be electrically connected in parallel, with the positive poles of at least two round cells being connected to one another and the negative poles of the round cells also being connected to one another. The positive poles and negative poles, respectively, may be electrically connected to each other using the cell connectors.

A module housing may be a supporting part of the battery module. The module housing can determine an orientation and position of the round cells in the battery module. Likewise, the module housing may determine an electrical interconnection of the round cells. The battery module may include a plurality of similar module housings. For example, round cells within a module housing may be connected in parallel in at least one group. The groups of multiple module housings may then be connected in series.

The module housing can isolate the cell cups of at least the series-connected round cells from each other. The stops have a dual functionality in that they serve as a stop surface for determining the position of the round cells. At the same time, the stops have a material thickness adapted to the voltage to be isolated in order to ensure a distance between the negative poles of the series-connected round cells.

An electrically insulating plastic material can be an injection-moldable thermoplastic. Then the module housing can be manufactured in an injection mold. The stops and recesses can be formed in the injection mold. Alternatively, the module housing can be manufactured in a thermoforming tool. The stops and recesses may then be punched. A foam material may be a multicomponent plastic. The foam material may foam in the foaming mold and fill a mold cavity. The foam material is porous and can be open-pored or closed-pored.

The module housing can be arranged in the foaming tool with the stops in front. The foam material can be metered into an interior space of the module housing. The module housing can be removed from the foaming tool after a reaction of the foam material with the foam body. Foam cores of the foaming tool that map the receptacles can be pulled out of the receptacles through the recesses. Foam cores can be placeholders for the receptacles. The foam material can foam up around the foam cores, forming the foam cores in the process. The foam cores can be inserted through the recesses when arranging the module housing in the foaming tool. The foam cores may have a cross-sectional area of the recesses. The foaming tool may be closed by a substantially flat lid. The foam material may react in a substantially pressureless manner. The foam material may be kept away from walls of the foaming tool by outer walls or side walls of the module housing. The foam material may bond to the walls of the module housing.

A diameter of the recesses may be smaller than a diameter of the cell cups. The diameter of the recesses can be larger than a diameter of the plus pole. The stop can be annular around the recess and completely cover the cell cup.

Alternatively, the diameter of the recesses can be larger than the diameter of the cell buckets. Several stops per recess can project into the recess. A clearance between the stops can be smaller than the diameter of the cell cups. The clear width can be larger than the diameter of the plus pole. The stops are not subjected to large mechanical loads. Only a small contact area is required to position the round cell.

The cell connectors can have crown-shaped contact springs on a side facing away from the round cells. One stop each can be arranged between a contact spring and the cell cup. The stops may be arranged at specific locations around the receptacle. Contact springs may be arranged around the positive pole of the round cell. The contact springs can be designed to make electrical contact at the cell cup of the next round cell in the series connection. As a result, the contact springs are arranged between the two round cells to be connected. The stops reliably prevent contact between the cell cup of the first round cell and the contact springs.

A diameter of the receptacles may be larger than the diameter of the cell cups. The foam body may have a plurality of squeeze ribs per receptacle extending axially along the receptacle. A clearance between the pinch ribs may be less than the diameter of the cell cups. A pinch rib may be an elevation on a surface of the receptacle. The pinch ribs may be distributed around the receptacle. In particular, the pinch ribs may be aligned with the stops. The pinch ribs may be formed by the foam cores.

The module housing may have through openings for the round cells aligned with the receptacles. A stop and a through opening may each be located on opposite sides of a receptacle. A diameter of the passage openings may be larger than the diameter of the cell cups. The through openings may reinforce the foam body.

The module housing can have two identical housing halves. The foam body can be arranged between the housing halves. In each housing half, the stops and the through openings can be arranged in rows next to each other. In each case, rows of stops and through openings may alternate. In the alternating rows, the round cells can be arranged in opposite directions. A round cell with its negative terminal may protrude from each through-opening. A positive pole may be arranged in each opening. By alternating the rows, a series connection of the round cells of the different rows can be easily established. The round cells of a row can be connected in parallel.

The module housing can have at least one connecting contour arranged on one housing side for connection to a further module housing of similar design. The connecting contour allows several module housings to be arranged one behind the other or next to each other or one above the other. The connection contour engages in a corresponding complementary connection contour of another module housing. The module housings are aligned with each other by the connection contour. The round cells in the module housing are also aligned with each other.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

An advantageous embodiment of the invention is explained below with reference to the accompanying figures, wherein:

FIG. 1 depicts a representation of a module housing according to an embodiment example;

FIG. 2 depicts spatial representation of a battery module according to an embodiment;

FIG. 3 depicts a sectional view of a detail of a battery module according to an embodiment;

FIG. 4 depicts an illustration of a module housing according to an embodiment;

FIG. 5 depicts a representation of a battery module according to an embodiment example; and

FIG. 6 depicts a spatial representation of a foaming tool with a module housing according to an embodiment example.

### DETAILED DESCRIPTION OF THE INVENTION

As used throughout the present disclosure, unless specifically stated otherwise, the term “or” encompasses all possible combinations, except where unfeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of” “A, B, and C” should be understood as including only one of A, only one of B, only one of C, or any combination of A, B, and C.

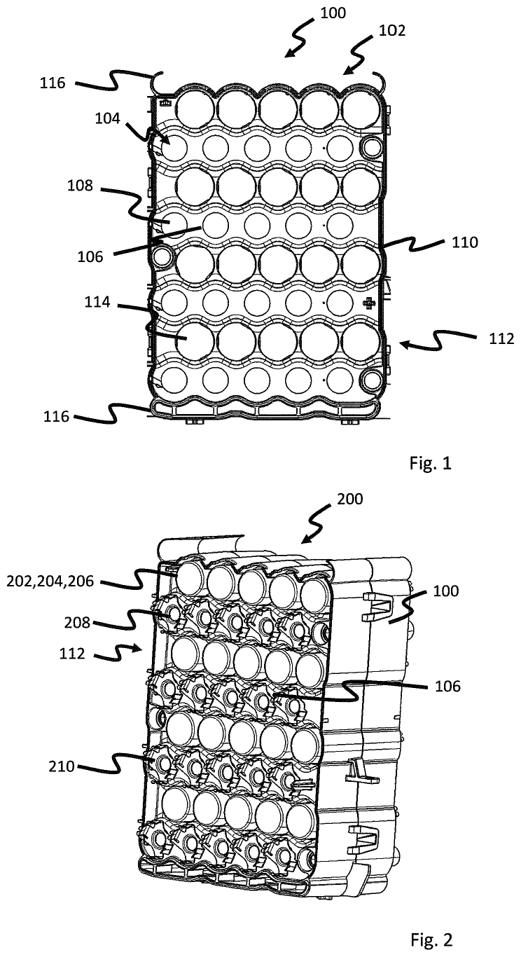

FIG. 1 depicts an illustration of a module housing 100 according to an embodiment of the present invention. The module housing 100 is made of an electrically insulating plastic material. The module housing 100 is an injection molded part. A foam body 102, made of an electrically insulating foam material, is disposed in the module housing 100. The foam body 102 has a plurality of receptacles 104 for round cells. In particular, the receptacles 104 are arranged as densely as possible. In this regard, a receptacle 104 is a cylindrical recess extending from one side of the foam body 102 to an opposite side of the foam body 102 and having a diameter adapted to a size of the round cell. Thus, the receptacles 104 are parallel aligned holes through the foam body 102 in a hexagonal packing.

The module housing 100 includes stops 106 aligned with the receptacles 104. The stops 106 each include a recess 108. When a round cell is placed in a receptacle 104, the round cell is inserted into the receptacle 104 with the positive pole first until a cell cup of the round cell rests against the stop 106 of the receptacle 104. The round cell cannot then be pushed further. The holder 104 fixes the round cell in the radial direction. The stop 106 fixes the round cell in the axial direction. The positive pole is arranged inside the recess 108 and can be contacted from the outside with a cell connector. The stop 106 covers the cell cup at least at the points where the cell connector is arranged.

Here, the recesses 108 are circular and have a smaller diameter than the receptacles 104, so the stops 106 are arranged in a circular ring around the recesses 108.

In another embodiment, the round cell is inserted into the receptacle 104 with the negative terminal first, with a corresponding adaptation of the electrical contacting.

In one embodiment, the module housing 100 is divided in two, with only one of the housing halves 110 shown here. In this case, the module housing 100 is designed to accommodate round cells oriented in opposite directions in each case. For this purpose, the receptacles 104 are grouped in rows 112. The housing half 110 has stops 106 only in every other row 112. In the other rows 112, the stops 106 are arranged in the other housing half 110 not shown here. In the rows 112 without stops 106, the housing half 110 has through openings 114. The through openings 114 have a larger diameter than the round cells.

In one embodiment, the module housing 100 has a connection contour 116 on at least one side for connection to a further module housing, in particular of the same type. Here, different connection contours are arranged on the upper and lower sides in the illustration. The connection contours 116 are complementary to each other.

FIG. 2 shows a spatial representation of a battery module 200 according to an embodiment. The battery module 200 has a module housing 100 corresponding to FIG. 1. Here, round cells 202 are arranged in the receptacles of the two-part module housing 100. The round cells 202 are inserted into the receptacles in opposite rows in each case, so that in each second row 112 the cell cups 204 of the round cells 202 protrude from the receptacles as negative poles 206 and in the other rows positive poles 208 of the round cells 202 are arranged in the recesses and the cell cups 204 rest against the stops 106. The positive poles 208 of a row 112 are each electrically conductively connected to one another by a cell connector 210. The stops 106 thereby insulate the cell connector 210 from the cell cups 204. In the illustrated embodiment example, the round cells 202 are 21700 cells with a nominal diameter of 21 millimeters and a nominal length of 700 millimeters. In another embodiment, the cells may be other round cells.

When another battery module is placed on top of the illustrated battery module 200, the cell connectors 210 connected to the positive terminals 208 contact the exposed negative terminals 206 of the other battery module 100 and connect the round cells 202 of the respective aligned rows 112 together in a series electrical circuit.

FIG. 3 depicts a sectional view of a detail of a battery module 200 according to an embodiment. The battery module 200 is essentially the same as the battery module 200 in FIG. 2. Here, the cell cup 204 of a round cell 202 is shown resting against the stop 106 of the module housing 100 and the positive terminal 208 is arranged in the recess 108. The cell connector 210 is electrically connected to the positive terminal 208. For this purpose, the cell connector 210 has an embossment 300 in the region of the positive pole 208, which, together with the projection of the positive pole 208 relative to the cell cup 204 or a cell shell, bridges a material thickness of the stop 106. For example, the positive pole 208 and the embossment 300 are welded together. The stop 106 is disposed as an insulator between the cell cup 204 and the cell connector 210 to prevent shorting of the round cell 202. The stop 106 is sized to provide the air gap and creepage distance between the cell connector 210 and the cell cup 204 required for cell voltage.

In one embodiment, the cell connector 210 includes contact springs 302 on a side facing away from the battery module 200. The contact springs 302 are bent up from a main plane of the cell connector 210 and are configured to circumferentially contact the cell cup of another round cell. For this purpose, the contact springs 302 have insertion slopes 304 over which the cell cup slides when two battery modules 200 are joined. The insertion slopes 304 elastically bend the contact springs 302 outward, thereby exerting a radial contact force on the cell cup.

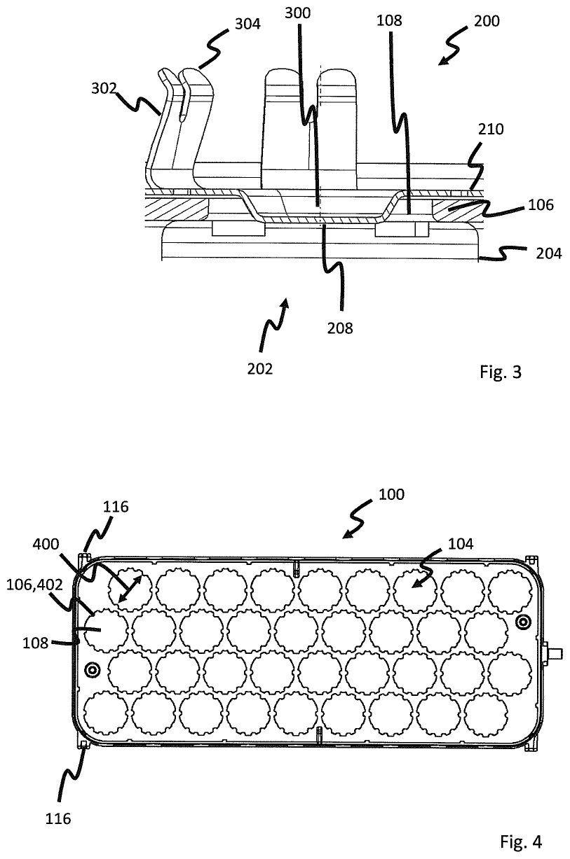

FIG. 4 depicts an illustration of a module housing 100 according to an embodiment. Like the module housing in FIG. 1, the module housing 100 has receptacles 104 arranged in hexagonal packing for round cells. Here, the recesses 108 in the module housing 100 have the diameter of the receptacles 104. A plurality of stops 106 are arranged distributed around the circumference of each recess 108 here. The stops 106 are approximately semicircular and project into the recess 108. A clearance 400 between tips of the stops 106 is less than the diameter of the recess 108, or less than the diameter of the round cells.

In this case, the stops 106 are arranged with respect to the recesses 108 as analog dials at 0:30, 1:30, 3:00, 4:30, 5:30, 6:30, 7:30, 9:00, 10:30 and 11:30. In a further embodiment, the arrangement may be different, in particular symmetrical.

In one embodiment, the diameters of the receptacles 104 and thus the diameters of the recesses 108 are slightly larger than the diameters of the round cells. To accommodate this, the foam body 102 has pinch ribs 402 extending axially along the walls of the receptacles 104 in extension of the stops 106. A clear width 400 between the tips of the pinch ribs 402 is smaller than the diameter of the round cells. The squeezing ribs 402 are at least partially elastically squeezed during insertion of the round cells and thus hold the round cells securely in the radial direction. The squeezing creates a contact pressure of the squeezing ribs 402 on the cell cup. The squeezing ribs 402 thereby provide a volume that can be squeezed during insertion. The volume of the squeezing ribs 402 is smaller than a volume to be displaced of a cylindrical recess with a corresponding clear width 400, in particular substantially smaller. Due to the squeezing ribs 402, the fixation of the round cells is less susceptible to tolerances than with a cylindrical recess alone. Even taking into account all given tolerances, the squeezable volume changes between a maximum squeeze case and a minimum squeeze case only in a ratio of 1.67:1. In another embodiment, the ratio may be different.

Like the module housing in FIG. 1, the module housing 100 includes complementary connection contours 116 on two opposite sides for connection to a similar module housing.

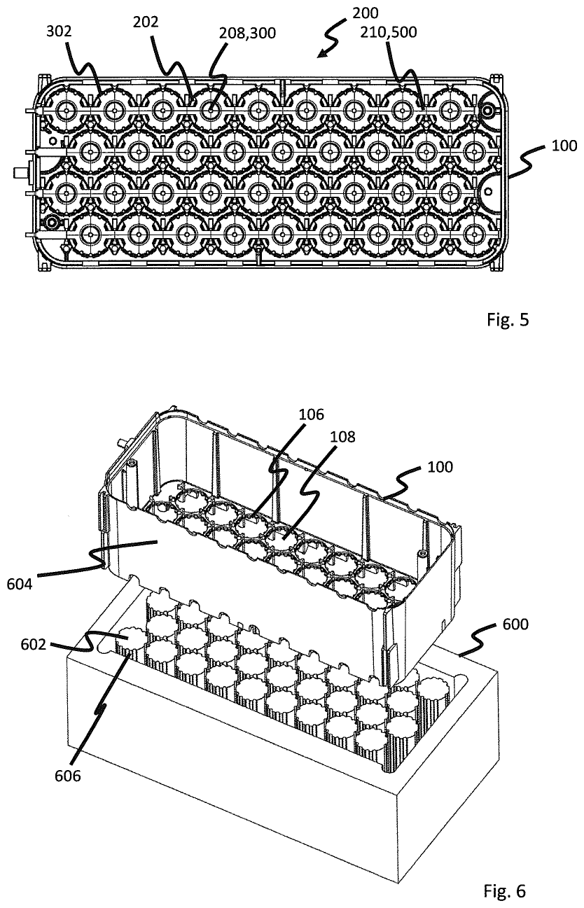

FIG. 5 depicts an illustration of a battery module 200 according to an embodiment. The battery module 200 has the module housing 100 of FIG. 4. In contrast to the illustration in FIG. 2, the round cells 202 are all inserted into the receptacles from the same side and in the same orientation until they rest against the stops. As a result, the positive terminals 208 and cell connectors 210 are all arranged on the same side of the battery module 200.

As in FIG. 3, the cell connectors 210 have embossings 300 and contact springs 302. Here, the cell connectors 210 have one embossing 300 and eight contact springs 302 per round cell 202. The contact springs 302 are arranged above the stops at 0:30, 1:30, 4:30, 5:30, 6:30, 7:30, 10:30 and 11:30. Connecting webs 500 are arranged above the stops at 3:00 and 9:00 between adjacent positive poles. In particular, contact springs 302 are arranged as closely as possible above the stops.

FIG. 6 depicts a spatial representation of a foaming tool 600 with a module housing 100 according to an embodiment. The module housing 100 corresponds essentially to the module housing 100 in FIG. 4. Here, no foam body is yet arranged in the module housing. The foam body is foamed using the foaming tool 600. Prior to foaming, the module housing 100 is injection molded from an electrically insulating plastic material in an injection molding tool. The module housing 100 is then inserted into the foaming tool 600 with the recesses 108 and stops 106 first. In this process, a foam core 602 of the foaming tool 600 is inserted into the module housing 100 through each recess 108. Side walls 604 of the module housing 100 are supported by side walls of the foaming tool 600. The foam cores 602 are placeholders for the receptacles of the foam body. The foam cores 602 are substantially cylindrical and substantially as long as the module housing 100 is tall. In order to be inserted, the foam cores 602 have cross-sectional surfaces corresponding to the recesses 108. The cross-sectional surfaces also map to the stops 106. As a result, the foam cores 602 seal the module housing 100 at the recesses 108 and stops 106, and an open-topped, sealed mold cavity is formed within the sidewalls 604 of the module housing 100. The stops 106 are shown on the foam cores 602 as axially extending grooves 606. The grooves 606 are imaged in the foam material during foaming to form the squeeze ribs extending axially along the receptacles.

For foaming, the foam material is metered into the mold cavity in liquid form. The mold cavity is then closed by a lid. The lid is not pressure-tight and can have pressure equalization openings. Foaming thus takes place without pressure. The side walls 604 are not deformed in the process. The foam material reacts in the mold cavity to form a solid foam, which completely molds the mold cavity including the foam cores 602. The foam material may also bond firmly to the sidewalls in the process. The foam cores 602 are configured such that the foam material does not firmly adhere to the foam cores 602. After the reaction is complete, the module housing with the foamed-in foam body is removed from the foaming tool 600. The foam cores 602 are thereby pulled out of the foam body again through the recesses 108.

In other words, a module housing with integrated cell fixing and positioning as well as short-circuit protection is presented.

In order to connect round cells to each other in series via a cell connector, in the automotive sector, unlike in the consumer sector, no electrically insulating heat shrink tubing applied to the cell sheath is usually used. The elimination of the heat shrink tubing saves material and costs and reduces the dimensional tolerances of the system.

However, the shrink tubing can fix an insulating washer, which may be necessary in the case of cell contacting by means of cell connectors. If, during assembly of the cell modules, the cells are not exactly aligned in the axial direction or the cell connectors have too small a diameter, the cell base of the second cell may collide with the cell connector of the first cell. This can lead to the cell connector being bent in such a way that it contacts the shell of the first cell and thus the negative terminal of the same cell, resulting in a short circuit and thus damage to the cell. Therefore, it is necessary to fix the insulating washer to the cell in a different way so that it cannot in any case become detached from the cells before the modules are mounted. The insulating washer can be glued, for example.

If modules do not have a positioning and fixing device, this can lead to the cells “wandering”/slipping within the modules during operation. This in turn can lead to the contact between the cells being interrupted, which can lead to either a partial or even complete failure of the battery. In the worst case, an electric arc could occur, which can lead to major damage or even fire to the battery.

The approach presented here positions and fixes the cells in the module housing in the axial direction. In addition, the approach presented here prevents an electrical short circuit in the event of a collision of the cell cup of another cell with the cell connector of the first cell during assembly.

During assembly, the cells are inserted with the positive pole first into the openings provided for this purpose in the module. The diameter of the openings can be the same or minimally larger than the diameter of the cells. The module is designed in such a way that the cell can only be inserted to the desired end position. This is achieved by the last opening being smaller than the cell. In this case, the positive pole of the cell looks out of this opening; the sheath (and thus the negative pole) is covered by the smaller housing opening. The opening is large enough to allow assembly of the cell connector (e.g., by welding). The opening is small enough to cover the cup shoulder of the cell.

The approach presented here achieves a saving in material as no insulating washers are used. Furthermore, a gain in electrical safety is achieved. There are advantages in terms of mechanical safety since a defined cell position is achieved.

For positioning and fixing the cells in the axial direction, a foam body with the corresponding openings is used to accommodate the cells. For simplified production, the aperture in the module housing has a special shape. This allows the foam cores to be demolded in the direction of the closed mold housing side. In this way, foaming can be carried out in the open shape of the mold.

The hole at the positive pole is nevertheless smaller than the cell diameter. The approach presented here allows the foam core, which has more or less the same diameter as the cell, to be pulled through a smaller hole, which represents the insulator or the stop.

The solution presented here is not to use a closed ring as a stop and insulator, but only partial constrictions around the circumference. The foam core thus has corresponding grooves, which then appear in the foam itself as “squeeze ribs” and thus additionally serve to fix the cell. The stops are positioned exactly at the points where the material of the cell crown is also located, because in areas between the contact springs of the cell crown and the connecting webs to the next cell crown, no short circuit to the cell shell can then occur. Thus, the stops are more or less hidden by the cell crown when viewed from above.

FIG. 4 depicts a simplified representation of a module housing. The insulators and stops are the 10 small protrusions in the 36 circles. They have defined positions resulting from the geometry of the cell crowns.

Thus, protrusions for the contact springs of the cell crowns are arranged at the positions 0:30, 1:30, 4:30, 5:30, 6:30, 7:30, 10:30 and 11:30 o'clock. Furthermore, protrusions for insulating the connecting webs of the cell crowns are arranged at the positions 3:00 and 9:00.

FIG. 6 depicts a schematic diagram of a foaming mold. It has an essentially rectangular cavity with 36 foam cores. Thus, a module housing can be inserted into this cavity with the opening pointing upwards. Subsequently, conditioned polyol-isocyanate mixture is metered into the open mold in the appropriate quantity by means of mixing equipment, and then the mold is closed with an appropriate cover. The compound now starts to react and expands, filling the entire cavity of the module housing. After the foam has reacted, the cover can be opened again, and the finished foamed module housing removed from the cavity. The result is a housing with a hard outer shell and soft holes inside, which then accommodate the cells.

The ribs created serve to fix the cells radially, as the foam adapts precisely to the cell diameter when the cells are inserted into the hole. The ribs thereby result in a small “displacement volume” with small joining forces. If, on the other hand, a cell were to be pressed into a circular hole matched to the smallest possible diameter of a cell, the forces would be much higher for a cell with a diameter at the upper tolerance limit, since the displacement volume would be larger. Fixation with ribs is less sensitive to tolerances than fixation without ribs.

Since the devices and methods described in detail above are examples of embodiments, they can be modified in the usual manner by the skilled person to a wide extent without leaving the scope of the invention. In particular, the mechanical arrangements and the proportions of the individual elements with respect to one another have been selected merely by way of example. All matter contained in the above description and shown in the accompanying drawings shall be interpreted as illustrative and not in a limiting sense.

What is claimed is:

1. A module housing of electrically insulating plastic material, the module housing comprising:
a foam body comprising electrically insulating foam material, the foam body having cylindrical receptacles configured for round cells,
axial stops arranged aligned with the receptacles and configured for cell cups of the round cells and recesses for positive poles of the round cells.

2. The module housing according to claim 1, wherein a diameter of the recesses is smaller than a diameter of the cell cups.

3. The module housing according to claim 1, wherein:
a diameter of the recesses is larger than a diameter of the cell cups, and
per recess, a plurality of stops protrude into the recess and a clearance between the stops is smaller than the diameter of the cell cups.

4. The module housing according to claim 1, wherein:
a diameter of the receptacles is greater than a diameter of the cell cups, the foam body having a plurality of squeeze ribs extending axially along the receptacle per receptacle, and
a clearance between the squeeze ribs is less than the diameter of the cell cups.

5. The module housing according to claim 1, further comprising passage openings configured for the round cells and aligned with the receptacles, and wherein a stop and a passage opening are each arranged on opposite sides of a receptacle.

6. The module housing according to claim 5, further comprising two housing halves, and wherein the foam body is arranged between the housing halves, wherein in each housing half the stops and the through openings are arranged in rows next to each other, and wherein rows of stops and through openings alternate in each case.

7. The module housing according to claim 1, further comprising a connecting contour arranged at least on one housing side and configured for connection to a further module housing of similar design.

8. A battery module comprising at least one module housing of electrically insulating plastic material having a foam body comprising electrically insulating foam material, the foam body having cylindrical receptacles configured for round cells, axial stops arranged aligned with the receptacles and configured for cell cups of the round cells and recesses for positive poles of the round cells, and wherein:
one round cell is arranged in the foam body for each receptacle,
cell cups of the round cells are arranged to bear against an inner side of the stops and positive poles of the round cells are arranged in the recesses,
cell connectors, configured to be electrically conductively connected to the positive poles, are arranged to abut on an outer side of the stops, and
wherein the cell connectors are electrically insulated from the cell cups by the stops.

9. The battery module according to claim 8, wherein:
the module housing further comprises a diameter of the recesses being larger than a diameter of the cell cups, and, per recess, a plurality of stops protrude into the recess and a clearance between the stops is smaller than the diameter of the cell cups,
the cell connectors have contact springs arranged to align in a crown shape on a side facing away from the round cells, and
a stop is arranged between each contact spring and the cell cup.

10. A method of manufacturing a module housing comprising stops, recesses, receptacles and axial stops, the method comprising the steps of:
manufacturing the module housing with stops and recesses from an electrically insulating plastic material; and
foaming a foam body with the receptacles from an electrically insulating foam material in a foaming tool; wherein
the foam body comprises electrically insulating foam material, the foam body having cylindrical receptacles configured for round cells, and
the axial stops are arranged aligned with the receptacles and configured for cell cups of the round cells and recesses for positive poles of the round cells.

11. The method according to claim 10, further comprising the steps of:
arranging the module housing in the foaming tool with the stops first, and
metering the foam material into an interior of the module housing,
removing the module housing from the foaming tool after a reaction of the foam material with the foam body,
pulling out the foam cores of the foaming tool mapping the receptacles out of the receptacles through the recesses.
